(19) United States
(12) Patent Application Publication
(10) Pub. No.: US 2021/0123001 A1
(43) Pub. Date: Apr. 29, 2021

(54) Cardamine hupingshanensis Selenium-enriched Chinese Yellow Rice Wine and Production Method

(71) Applicant: Shaanxi University of Technology, Hanzhong (CN)

(72) Inventors: Jingzhang GENG, Hanzhong (CN); Dongqin LI, Hanzhong (CN); Meng YANG, Hanzhong (CN); Hai JIANG, Hanzhong (CN)

(73) Assignee: Shaanxi University of Technology, Hanzhong (CN)

(21) Appl. No.: 17/015,110

(22) Filed: Sep. 9, 2020

(30) Foreign Application Priority Data
Oct. 28, 2019 (CN) 201911029734.1

(51) Int. Cl. C12G 3/022; A23L 5/10; C12H 1/07; C12H 1/18; C12G 3/026

(52) U.S. Cl. CPC C12G 3/022; A23L 5/13; A23V 2002/00; C12H 1/18; C12G 3/026; C12H 1/063

(57) ABSTRACT

A Cardamine hupingshanensis selenium-enriched Chinese yellow rice wine and a production method are provided. The production method is performed as follows. Fresh C. hupingshanensis is selected, followed by preparing the C. hupingshanensis into a juice containing effective components of C. hupingshanensis, or C. hupingshanensis powder. Glutinous rice raw materials are soaked in clear water, followed by taking out and steaming to obtain steamed glutinous rice. The steamed glutinous rice is cooled and mixed with distillers' yeast for pre-fermentation, after a temperature of fermented material rising to a harrowing temperature, a pre-fermented product is obtained by harrowing regularly. A post-fermentation is performed, followed by performing a pressure filtration. A pressure filtrate is put aside for clarification, followed by filtering and sterilizing, then adding the juice. Alternatively, the C. hupingshanensis powder is added into the pre-fermented product, followed by post-fermenting, then performing pressure filtration and filtering and sterilizing pressure filtrate.

### CROSS REFERENCE TO THE RELATED APPLICATIONS

This application is based upon and claims priority to Chinese Patent Application No. 201911029734.1, filed on Oct. 28, 2019, the entire contents of which are incorporated herein by reference.

### TECHNICAL FIELD

The present invention relates to the technical field of yellow rice wine brewing, and more particularly, relates to a Cardamine hupingshanensis selenium-enriched Chinese yellow rice wine and a production method thereof.

### BACKGROUND

Chinese yellow rice wine is a special product of China, which ranks with beer and grape wine as the three ancient wines in the world. Its brewing technology is unique and has become a typical representative and model in Oriental brewing industry. It contains more than 5000 years of historical and cultural accumulation in China and enjoys a reputation of “national wine”. Chinese yellow rice wine is unique for it is considered a full bodied wine while easy to drink, it has a mellow taste, contains rich nutrition and low alcohol content, it is often used in food therapy and medical treatment—a new consumption value trend of the society.

Selenium is one of the indispensable elements in human body. The intake of selenium is closely related to health, and plant organic selenium has become a basic source of people. Cardamine hupingshanensis (C. hupingshanensis) is rich in vitamin C, vitamin B1, vitamin B2 and nicotinic acid, especially, the content of vitamin B1 is 9-14 times that of bok choy, a popular green leaved vegetable commonly consumed in China. Additionally, C. hupingshanensis contains a wide range of essential amino acids, of which a total content of three limiting amino acids: lysine, threonine and methionine accounts for 10.3% of total amino acids. Content of Se, Ca, Mg and Mn in mineral elements of C. hupingshanensis is high, especially Se. Currently, C. hupingshanensis has been used as raw materials in large-scaled artificial domestication and cultivation of wild varieties. However, there is a lack of theoretical research on the development of C. hupingshanensis, and relevant products are still in a stage of crude products; product development is mainly focused on using selenium-enriched substances in its materials as additive ingredients in feed. Research on Se-containing protein and Se-containing polysaccharide in C. hupingshanensis has been reported, but it still stays at a small-scale stage in the laboratory, and the research and development of related products of C. hupingshanensis is rarely reported.

### SUMMARY

The purpose of the present invention is to provide a Cardamine hupingshanensis selenium-enriched Chinese yellow rice wine and a production method thereof, which serves as an application for developing a new C. hupingshanensis product.

The present invention is realized by the following technical scheme. A production method of a Cardamine hupingshanensis selenium-enriched Chinese yellow rice wine, including the following steps:

step 1: selecting fresh C. hupingshanensis, and preparing into a juice containing effective components of C. hupingshanensis, or alternatively, drying the fresh C hupingshanensis to a moisture content of 10-12% and crushing to obtain C. hupingshanensis powder;

step 2: soaking glutinous rice raw materials in clear water to let them absorb water, once they have fully expand after absorbing water, taking the glutinous rice out and steaming to obtain steamed. After the glutinous rice are fully steamed, cooling the steamed glutinous rice to 28-30° C., and mixing with distillers' yeast and pre-fermenting at 28-30° C. in a fermentation tank, after a temperature of fermented material rising to 32-35° C., harrowing regularly (regulating temperature of the fermented material and replenishing oxygen by stirring regularly) to obtain a pre-fermented product;

step 3: performing a post-fermentation on the pre-fermented product at 10-20° C. to obtain a post-fermented product, perform a pressure filtration on the post-fermented product, putting a pressure filtrate aside at −5-0° C. for clarification, and filtering and placing the pressure filtrate in ohmic heating equipment for heating and sterilization, after the heating and sterilization, adding 30-50 mL of the juice containing effective components of C. hupingshanensis into each liter of the pressure filtrate to obtain the C. hupingshanensis selenium-enriched Chinese yellow rice wine;

or adding the C. hupingshanensis powder into the pre-fermented product, performing a post-fermentation at 10-20° C. and then performing pressure filtration, putting a pressure filtrate for clarification, and filtering and placing the pressure filtrate in ohmic heating equipment for heating and sterilization to obtain the C. hupingshanensis selenium-enriched Chinese yellow rice wine, the quality of the C. hupingshanensis powder, for example, is 5-10% of a quality of the glutinous rice raw materials.

Further, a method for preparing the juice containing effective components of C. hupingshanensis in step 1 is as follows: cleaning C. hupingshanensis, removing impurities and squeezing juice.

Further, a method for preparing the juice containing effective components of C. hupingshanensis in step 1 is as follows: drying C. hupingshanensis to a moisture content of 10-12% and crushing to 80-120 mesh to obtain crushed C. hupingshanensis, taking the crushed C. hupingshanensis and water according to a mass ratio of 1:(2-3), soaking the crushed C. hupingshanensis in water for 1-2 h, and extracting an extract containing effective components of C. hupingshanensis by an extraction method.

Further, the soaking in step 2 is performed at 10-20° C. for 5-7 days.

Further, a pre-fermentation time in step 2 is 7-10 days.

Further, an interval of harrowing in step 2 is 4-6 h, and a number of harrowing is 15-30.

Further, a post-fermentation time in step 3 is 30-60 days.

Further, in step 3, the pressure filtrate is put aside in refrigeration equipment at −5-0° C. for 12-24 h.

Further, the heating and sterilization in step 3 is performed at 80-85° C. for 5-10 min.

Further, the C. hupingshanensis selenium-enriched Chinese yellow rice wine prepared based on the above production method has a total selenium content of 60-200 μg/L, and an organic selenium content of 50-180 μg/L.

Compared with the prior art, the present invention has the following advantages:

The present invention provides a C. hupingshanensis selenium-enriched Chinese yellow rice wine and a production method thereof. The C. hupingshanensis is added to Chinese yellow rice wine in different forms at different stages of making wine to obtain imitation wine and fermented wine, and to prepare a new Chinese yellow rice wine drink with effective components of C. hupingshanensis. Utilization rate of functional factors in C. hupingshanensis is improved by microbial fermentation decomposition or soaking extraction. Raw material of C. hupingshanensis rich in oligosaccharides and other effective components is added into the pre-fermented product for co-fermentation, which provides rich nutrients for microorganisms and promotes fermentation, thereby improving an utilization rate of glutinous rice while decomposing beneficial components in C. hupingshanensis to a certain degree. A glutinous yellow rice wine is used as a base wine and the juice containing effective components of C. hupingshanensis is directly added therein to obtain imitation wine, which facilitates an absorption and utilization of nutrients in C. hupingshanensis in human body due to an effect of activating blood circulation of the yellow rice wine. In addition, sterilization of prepared yellow rice wine is performed by heating in ohmic heating equipment, which uses low-frequency alternative current (AC) power supply, yellow rice wine contains organic acids and other electrolytes, when the current passes through the yellow rice wine, electrical energy will be rapidly converted into heat energy in the yellow rice wine because of conductivity and electrical impedance characteristics of yellow rice wine itself, causing temperature to rise, so as to achieve the purpose of rapid heating. Compared with a traditional heating method, ohmic heating has advantages of fast heating speed, uniform heating, less mechanical damage to products, high energy efficiency, low energy consumption, etc.

### DETAILED DESCRIPTION OF THE EMBODIMENTS

Specific embodiments are listed below.

### Embodiment 1

A production method of a Cardamine hupingshanensis selenium-enriched Chinese yellow rice wine includes the following steps.

Step 1: Fresh C. hupingshanensis which is new harvest born in current year, free of pesticide and chemical fertilizer pollution is selected, followed by cleaning C. hupingshanensis, removing impurities and squeezing juice, or drying C. hupingshanensis to a moisture content of 10% and crushing to 80 mesh. Crushed C. hupingshanensis and water are taken according to a mass ratio of 1:2, followed by soaking the crushed C. hupingshanensis in the water for 2 h, and extracting an extract containing effective components of C. hupingshanensis by an extraction method to obtain a juice containing effective components of C. hupingshanensis; or drying C. hupingshanensis at a low temperature to a moisture content of 10% and crushing to 80 mesh to obtain C. hupingshanensis powder.

Step 2: Glutinous rice raw materials are removed from impurities, weighed and cleaned, followed by soaking in clear water at 20° C. for 5 days to absorb water and expand, then taking out and steaming to obtain steamed glutinous rice. The steamed glutinous rice is cooled to 28° C., followed by mixing with distillers' yeast and pre-fermenting at 28° C. for 7 days in a fermentation tank, harrowing when a temperature of fermented material rising to 35° C. once for each 4 h and total 15 times to obtain a pre-fermented product.

Step 3:A post-fermentation is performed on the pre-fermented product at 10° C. for 60 days, followed by performing a conventional pressure filtration. A pressure filtrate is put aside at −5° C. in refrigeration equipment for 24 h for clarification, followed by filtering then sterilizing the filtered pressure filtrate in ohmic heating equipment at 85° C. for 10 min, and adding 50 mL of the juice containing effective components of C. hupingshanensis into each liter of the sterilized pressure filtrate to obtain the C. hupingshanensis selenium-enriched Chinese yellow rice wine.

Alternatively, the C. hupingshanensis powder is added into the pre-fermented product, a post-fermentation is performed at 10° C. for 60 days and then a conventional pressure filtration is performed. A pressure filtrate is put aside at −5° C. in refrigeration equipment for 24 h for clarification, followed by filtering and then sterilizing the filtered pressure filtrate in ohmic heating equipment at 85° C. for 10 min to obtain the C. hupingshanensis selenium-enriched Chinese yellow rice wine, wherein a quality of the C. hupingshanensis powder is 7% of a quality of the glutinous rice raw materials.

A total selenium content in the prepared C. hupingshanensis selenium-enriched Chinese yellow rice wine product is 135 μg/L, in which an organic selenium content is 115 μg/L.

### Embodiment 2

A production method of a Cardamine hupingshanensis selenium-enriched Chinese yellow rice wine includes the following steps.

Step 1: Fresh C. hupingshanensis which is new harvest born in current year, free of pesticide and chemical fertilizer pollution is selected, followed by cleaning C. hupingshanensis, removing impurities and squeezing juice, or drying C. hupingshanensis to a moisture content of 12% and crushing to 120 mesh. Crushed C. hupingshanensis and water are taken according to a mass ratio of 1:3, followed by soaking the crushed C. hupingshanensis in the water for 2 h, and extracting an extract containing effective components of C. hupingshanensis by an extraction method to obtain a juice containing effective components of C. hupingshanensis; or drying C. hupingshanensis at a low temperature to a moisture content of 12% and crushing to 120 mesh to obtain C. hupingshanensis powder.

Step 2: Glutinous rice raw materials are removed from impurities, weighed and cleaned, followed by soaking in clear water at 10° C. for 7 days to absorb water and expand, then taking out and steaming to obtain steamed glutinous rice. The steamed glutinous rice is cooled to 30° C., followed by mixing with distillers' yeast and pre-fermenting at 30° C. for 7 days in a fermentation tank, harrowing when a temperature of fermented material rising to 35° C. once for each 4 h and total 15 times to obtain a pre-fermented product.

Step 3: A post-fermentation is performed on the pre-fermented product at 20° C. for 30 days, followed by performing a conventional pressure filtration. A pressure filtrate is put aside at 0° C. in refrigeration equipment for 12 h for clarification, followed by filtering, then sterilizing the filtered pressure filtrate in ohmic heating equipment at 85° C. for 10 min, and adding 50 mL of the juice containing effective components of C. hupingshanensis into each liter of the sterilized pressure filtrate to obtain the C. hupingshanensis selenium-enriched Chinese yellow rice wine.

Alternatively, the C. hupingshanensis powder is added into the pre-fermented product, followed by post-fermenting at 20° C. for 30 days and then performing a conventional pressure filtration. A pressure filtrate is put aside at 0° C. in refrigeration equipment for 12 h for clarification, followed by filtering and sterilizing the filtered pressure filtrate in ohmic heating equipment at 80° C. for 5 min to obtain the C. hupingshanensis selenium-enriched Chinese yellow rice wine, wherein a quality of the C. hupingshanensis powder is 10% of a quality of the glutinous rice raw materials.

A total selenium content in the prepared C. hupingshanensis selenium-enriched Chinese yellow rice wine product is 200 μg/L, in which an organic selenium content is 180 μg/L.

Hypoglycemic Experiment of C. Hupingshanensis Selenium-Enriched Chinese Yellow Rice Wine

Animal model of hyperglycemia induced by insulin is adopted: experimental group 1, experimental group 2, model group and blank group are set up, with 15 mice in each group. The Experimental group 1, experimental group 2 and model group are injected with alloxan to create models. Hyperglycemia model is established with blood glucose value of 10-25 mmol/L. The blank control group is not treated. Test samples are given for 30 days, and the experimental groups 1 and 2 are fed with 5.0 g/kg of C. hupingshanensis selenium-enriched Chinese yellow rice wine produced in embodiment 1 and embodiment 2, respectively, and fasting blood glucose value is measured. Blood glucose values and decreasing percentages of blood glucose value in experimental group 1, the experimental group 2 and the model group are compared, and the results show that: the fasting blood glucose value of the experimental group 1 decreases by 13.6%; the fasting blood glucose value of the experimental group 2 decreases by 14.7%; the fasting blood glucose value of the blank group decreases by −0.25%; and the fasting blood glucose value of the model group decreases by −0.23%. There is no significant difference in blood glucose value between the model group and the blank group before and after the experiment (P≥0.05), which determines a validity of the experiment. There is significant difference in blood glucose value before and after the experiment in the experimental groups 1 and 2 (P≤0.05). It is judged that the products of the embodiments 1 and 2 have an improvement effect on blood glucose value decrease of experimental animals, and the C. hupingshanensis selenium-enriched Chinese yellow rice wine has a hypoglycemic effect.

Hypolipidemic Experiment of C. Hupingshanensis Selenium-Enriched Chinese Yellow Rice Wine

Insulin resistance and glucose/lipid metabolism disorder model is used as experimental model. Experimental group 1, experimental group 2, model group and blank group are set up, with 15 mice in each group. The experimental groups 1 and group 2 are fed with 5.0 g/kg of C. hupingshanensis selenium-enriched Chinese yellow rice wine produced in embodiment 1 and embodiment 2, respectively. The blank control group is not treated, and the model group is given with the same volume of solvent. Fasting for 3-4 h, serum total cholesterol (TC) and a level of triglyceride (TG) are detected. The TC, TG and percentage of decrease are compared among the experimental groups 1 and 2 and the model group. Results show that: TC decreases by 14.5% and TG decreases by 19.2% in the experimental group 1; TC decreases by 13.7% and TG decreases by 18.5% in the experimental group 2; TC decreases by 2.1% and TG decreases by 1.2% in the blank group; and TC decreases by 3.0% and TG decreases by 1.2% in the model group. Results show that there is significant difference between the experimental groups 1, 2 and the model group, the blank group in percentage of blood lipid value decrease before and after the experiment. It is judged that the products of the embodiments 1 and 2 have an improvement effect evidenced by the experimental animals' blood lipid value decrease as the C. hupingshanensis selenium-enriched Chinese yellow rice wine has a hypolipidemic effect.

### Embodiment 3

A production method of a Cardamine hupingshanensis selenium-enriched Chinese yellow rice wine includes the following steps.

Step 1: Fresh C. hupingshanensis which is new harvest born in current year, free of pesticide and chemical fertilizer pollution is selected, followed by cleaning C. hupingshanensis, removing impurities and squeezing juice, or drying C. hupingshanensis to a moisture content of 11% and crushing to 100 mesh. Crushed C. hupingshanensis and water are taken according to a mass ratio of 1:2.5, followed by soaking the crushed C. hupingshanensis in the water for 1 h, and extracting an extract containing effective components of C. hupingshanensis by an extraction method to obtain a juice containing effective components of C. hupingshanensis; or drying C. hupingshanensis at a low temperature to a moisture content of 11% and crushing to 100 mesh to obtain C. hupingshanensis powder.

Step 2: Glutinous rice raw materials are removed from impurities, weighed and cleaned, followed by soaking in clear water at 15° C. for 6 days to absorb water and expand, then taking out and steaming to obtain steamed glutinous rice. The steamed glutinous rice is cooled to 29° C., followed by mixing with distillers' yeast and pre-fermenting at 29° C. for 10 days in a fermentation tank, harrowing when a temperature of fermented material rising to 32° C. once for each 6 h and total 30 times to obtain a pre-fermented product.

Step 3: A post-fermentation is performed on the pre-fermented product at 15° C. for 40 days, followed by performing a conventional pressure filtration. A pressure filtrate is put aside at −3° C. in refrigeration equipment for 15 h for clarification, followed by filtering, then sterilizing the filtered pressure filtrate in ohmic heating equipment at 80° C. for 8 min, and adding 40 mL of the juice containing effective components of C. hupingshanensis into each liter of the sterilized pressure filtrate to obtain the C. hupingshanensis selenium-enriched Chinese yellow rice wine.

Alternatively, the C. hupingshanensis powder is added into the pre-fermented product, followed by post-fermenting at 15° C. for 40 days and then performing a conventional pressure filtration. A pressure filtrate is put aside at −3° C. in refrigeration equipment for 15 h for clarification, followed by filtering and sterilizing the filtered pressure filtrate in ohmic heating equipment at 80° C. for 8 min to obtain the C. hupingshanensis selenium-enriched Chinese yellow rice wine, wherein a quality of the C. hupingshanensis powder is 8% of a quality of the glutinous rice raw materials.

A total selenium content in the prepared C. hupingshanensis selenium-enriched Chinese yellow rice wine product is 160 μg/L, in which an organic selenium content is 140 μg/L.

### Embodiment 4

A production method of a Cardamine hupingshanensis selenium-enriched Chinese yellow rice wine includes the following steps.

Step 1: Fresh C. hupingshanensis which is new harvest born in current year, free of pesticide and chemical fertilizer pollution is selected, followed by cleaning C. hupingshanensis, removing impurities and squeezing juice, or drying C. hupingshanensis to a moisture content of 12% and crushing to 90 mesh. Crushed C. hupingshanensis and water are taken according to a mass ratio of 1:3, followed by soaking the crushed C. hupingshanensis in the water for 1.5 h, and extracting an extract containing effective components of C. hupingshanensis by an extraction method to obtain a juice containing effective components of C. hupingshanensis; or drying C. hupingshanensis at a low temperature to a moisture content of 12% and crushing to 90 mesh to obtain C. hupingshanensis powder.

Step 2: Glutinous rice raw materials are removed from impurities, weighed and cleaned, followed by soaking in clear water at 18° C. for 6 days to absorb water and expand, then taking out and steaming to obtain steamed glutinous rice. The steamed glutinous rice is cooled to 29° C., followed by mixing with distillers' yeast and pre-fermenting at 29° C. for 8 days in a fermentation tank, harrowing when a temperature of fermented material rising to 34° C. once for each 5 h and total 20 times to obtain a pre-fermented product.

Step 3: A post-fermentation is performed on the pre-fermented product at 15° C. for 50 days, followed by performing a conventional pressure filtration. A pressure filtrate is put aside at −4° C. in refrigeration equipment for 18 h for clarification, followed by filtering, then sterilizing the filtered pressure filtrate in ohmic heating equipment at 83° C. for 5 min, and adding 50 mL of the juice containing effective components of C. hupingshanensis into each liter of the sterilized pressure filtrate to obtain the C. hupingshanensis selenium-enriched Chinese yellow rice wine.

Alternatively, the C. hupingshanensis powder is added into the pre-fermented product, followedd by post-fermenting at 15° C. for 50 days and then performing a conventional pressure filtration. A pressure filtrate is put aside at −4° C. in refrigeration equipment for 18 h for clarification, followed by filtering and sterilizing the filtered pressure filtrate in ohmic heating equipment at 83° C. for 5 min to obtain the C. hupingshanensis selenium-enriched Chinese yellow rice wine, wherein a quality of the C. hupingshanensis powder is 9% of a quality of the glutinous rice raw materials.

A total selenium content in the prepared C. hupingshanensis selenium-enriched Chinese yellow rice wine product is 170 μg/L, in which an organic selenium content is 150 μg/L.

Sensory indexes of the prepared C. hupingshanensis selenium-enriched Chinese yellow rice wine are as follows. The prepared C. hupingshanensis selenium-enriched Chinese yellow rice wine shows a clear and transparent color, a unique mellow smell, and a mellow, refreshing and pure taste.

Physicochemical indexes of C. hupingshanensis Selenium-Enriched Chinese Yellow Rice Wine

| Item | Index |
|---|---|
| Total selenium/(μg/L) | 60-200 |
| Organic selenium/(μg/L) | 50-180 |
| Non-sugar solids/(g/L) | ≥7.0 |
| Alcohol (20° C.)/(% vol) | ≥8 |
| pH | 3.5-4.6 |
| Total acid (in terms of lactic acid)/(g/L) | 1.0-5.5 |
| Amino acid nitrogen/(g/L) | ≥0.3 |
| Lead (in terms of Pb) (mg/L) | ≤0.5 |
| Calcium oxide/(g/L) | ≤0.5 |

What is claimed is:

1. A method for producing a Cardamine hupingshanensis (C. hupingshanensis) selenium-enriched Chinese yellow rice wine, comprising:
step 1: selecting C. hupingshanensis, and preparing the C. hupingshanensis into a juice containing effective components of the C. hupingshanensis, or drying the C. hupingshanensis to a moisture content of 10-12% and crushing the C. hupingshanensis to obtain C. hupingshanensis powder;
step 2: soaking glutinous rice raw materials in clear water to absorb water and expand to obtain soaked glutinous rice, taking out the soaked glutinous rice and steaming the soaked glutinous rice to obtain steamed glutinous rice, cooling the steamed glutinous rice to 28-30° C., and mixing the steamed glutinous rice with distillers' yeast to obtain a first mixed product, and pre-fermenting the first mixed product at 28-30° C. in a fermentation tank to obtain fermented material, after a temperature of the fermented material rising to 32-35° C., harrowing regularly (regulating temperature of the fermented material and replenishing oxygen by stirring regularly) to obtain a pre-fermented product;
step 3: performing a post-fermentation on the pre-fermented product at 10-20° C., performing a pressure filtration to obtain a first pressure filtrate, putting the first pressure filtrate aside at −5-0° C. for clarification, filtering the first pressure filtrate to obtain a second pressure filtrate, then heating and sterilizing the second pressure filtrate in ohmic heating equipment, and after heating and sterilizing, adding 30-50 mL of the juice containing the effective components of the C. hupingshanensis into each liter of the second pressure filtrate to obtain the C. hupingshanensis selenium-enriched Chinese yellow rice wine;
wherein as an option, step 3 comprises adding the C. hupingshanensis powder into the pre-fermented product to obtain a second mixed product, post-fermenting the second mixed product at 10-20° C. and then performing a pressure filtration to obtain a third pressure filtrate, putting the third pressure filtrate aside for clarification, filtering the third pressure filtrate to obtain a fourth pressure filtrate, and then heating and sterilizing the fourth pressure filtrate in the ohmic heating equipment to obtain the C. hupingshanensis selenium-enriched Chinese yellow rice wine, wherein a quality of the C. hupingshanensis powder is 5-10% of a quality of the glutinous rice raw materials.

2. The method for producing the Cardamine hupingshanensis selenium-enriched Chinese yellow rice wine according to claim 1, wherein a method for preparing the juice containing the effective components of the C. hupingshanensis in step 1 is as follows: cleaning the C. hupingshanensis, removing impurities from the C. hupingshanensis and squeezing the C. hupingshanensis into the juice.

3. The method for producing the Cardamine hupingshanensis selenium-enriched Chinese yellow rice wine according to claim 1, wherein a method for preparing the juice containing the effective components of the C. hupingshanensis in step 1 is as follows: drying the C. hupingshanensis to a moisture content of 10-12% to obtain dried C. hupingshanensis and crushing the dried C. hupingshanensis to 80-120 mesh to obtain crushed C. hupingshanensis, taking the crushed C. hupingshanensis and water according to a mass ratio of 1:(2-3), soaking the crushed C. hupingshanensis in the water for 1-2 h, and extracting an extract containing the effective components of the C. hupingshanensis by an extraction method.

4. The method for producing the Cardamine hupingshanensis selenium-enriched Chinese yellow rice wine according to claim 1, wherein the soaking in step 2 is performed at 10-20° C. for 5-7 days.

5. The method for producing the Cardamine hupingshanensis selenium-enriched Chinese yellow rice wine according to claim 1, wherein a pre-fermentation time in step 2 is 7-10 days.

6. The method for producing the Cardamine hupingshanensis selenium-enriched Chinese yellow rice wine according to claim 1, wherein an interval of the harrowing in step 2 is 4-6 h, and a number of the harrowing is 15-30.

7. The method for producing the Cardamine hupingshanensis selenium-enriched Chinese yellow rice wine according to claim 1, wherein a post-fermentation time in step 3 is 30-60 days.

8. The method for producing the Cardamine hupingshanensis selenium-enriched Chinese yellow rice wine according to claim 1, wherein in step 3, the first pressure filtrate or the third pressure filtrate is put aside in refrigeration equipment at −5-0° C. for 12-24 h.

9. The method for producing the Cardamine hupingshanensis selenium-enriched Chinese yellow rice wine according to claim 1, wherein the heating and sterilizing in step 3 is performed at 80-85° C. for 5-10 min.

10. A C. hupingshanensis selenium-enriched Chinese yellow rice wine prepared based on the method according to claim 1, wherein the C. hupingshanensis selenium-enriched Chinese yellow rice wine has a total selenium content of 60-200 μg/L, and an organic selenium content of 50-180 μg/L.
